(19) United States
(12) Patent Application Publication
(10) Pub. No.: US 2003/0222209 A1
(43) Pub. Date: Dec. 4, 2003

(54) Compact, large angle beam stabilization module

(76) Inventor: Phillip V. Mitchell, Laguna Niguel, CA (US)

Correspondence Address: IRELL & MANELLA LLP, 840 NEWPORT CENTER DRIVE, SUITE 400, NEWPORT BEACH, CA, 92660, US

(21) Appl. No.: 10/163,190

(22) Filed: Jun. 4, 2002

(51) Int. Cl. G01D 5/34

(52) U.S. Cl. 250/231.1

(57) ABSTRACT

A laser beam stabilization module that has a tilt compensation device and a separate displacement compensation device. Each compensation device is coupled to a feedback loop to correct for tilt and displacement errors in a laser beam stabilized by the module. Providing a pure displacement compensation device eliminates the additional tilt error found in two mirror stabilization modules of the prior art.

### BACKGROUND OF THE INVENTION

1. Field of the Invention

The subject matter disclosed generally relates to the field of laser beam stabilization modules.

2. Background Information

Manufacturing process equipment may contain a laser to perform work on a piece part. For example, semiconductor fabrication equipment utilize lasers to perform photolithographic processes. Fabrication equipment may be subjected to vibration loads that vary the location of the laser beam and reduce the accuracy of the process. Additionally, commercial lasers are subject to drift which also changes the position of the laser beam. It is desirable to integrate a stabilization system into the equipment that will maintain a desired location of the laser beam.

FIG. 1 shows a laser beam stabilization system 1 of the prior art. The stabilization system 1 maintains a position of a laser beam 2 emitted by a laser 3 and reflected by bending mirrors 4. The system 1 includes a first fast steering mirror (FSM) 5 and a second fast steering mirror 6 that can adjust the position of the laser beam 2. Each FSM 5 and 6 includes a reflective mirror 7 that is pivoted by a plurality of actuators 8.

The actuators 8 receive input signals from a controller 9. The controller 9 receives error signals from a pair of photodetectors 10 and 11. A portion of the laser beam 2 is reflected onto the photodetectors 10 and 11 by mirrors 12. Photodetector 10 is used to determine a displacement error in the location of the laser beam 2. Photodetector 11 is used to determine a tilt error in the location of the laser beam 2.

The first FSM 5 is pivoted to correct for any undesired lateral displacement of the laser beam 2. The second FSM 6 is then pivoted to correct for an undesired angle or tilt in the laser beam 2. Unfortunately, the second FSM 6 must compensate for not only the tilt error in the laser beam but the additional tilt angle created by the pivoting first FSM 5. This reduces the dynamic range for correcting tilt error. The tilt of the first FSM 5 can be minimized by placing the second FSM 6 far away from FSM 5, but this increases the size of the stabilization system 1. Additionally, the residual error in the system is also increased by the larger input error to the second FSM 6.

### BRIEF SUMMARY OF THE INVENTION

A stabilization module for a light beam that travels along an optical path. The module includes a tilt compensation device and a displacement compensation device located along the optical path. A tilt feedback assembly is coupled to the tilt compensation device. A displacement feedback assembly is coupled to the displacement compensation device.

### BRIEF DESCRIPTION OF THE DRAWINGS

FIG. 1 is a schematic of a stabilization module of the prior art;

FIG. 2 is a schematic of a stabilization module;

FIG. 3 is a schematic of an embodiment of the stabilization module; and,

FIG. 4 is a schematic of an alternate embodiment of the stabilization module;

FIG. 5 is a schematic of an alternate embodiment of the stabilization module.

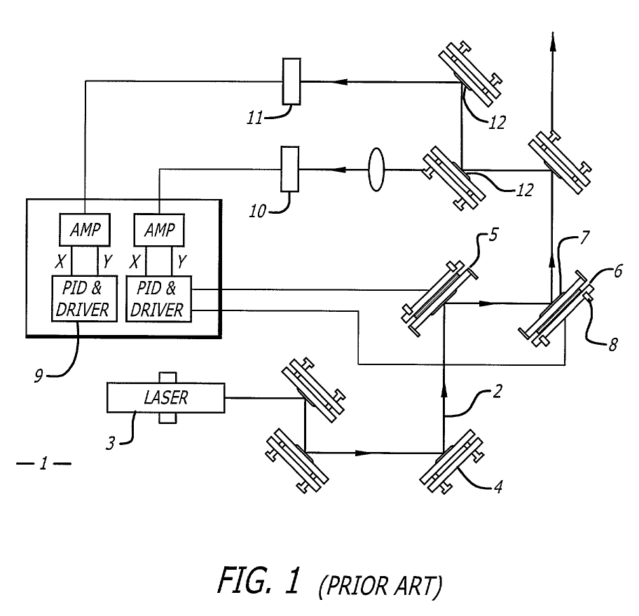

### DETAILED DESCRIPTION

Disclosed is a laser beam stabilization module that has a tilt compensation device and a separate displacement compensation device. Each compensation device is coupled to a feedback loop to correct for tilt and displacement errors in a laser beam stabilized by the module. Providing a pure displacement compensation device eliminates the additional tilt error found in two mirror stabilization modules of the prior art.

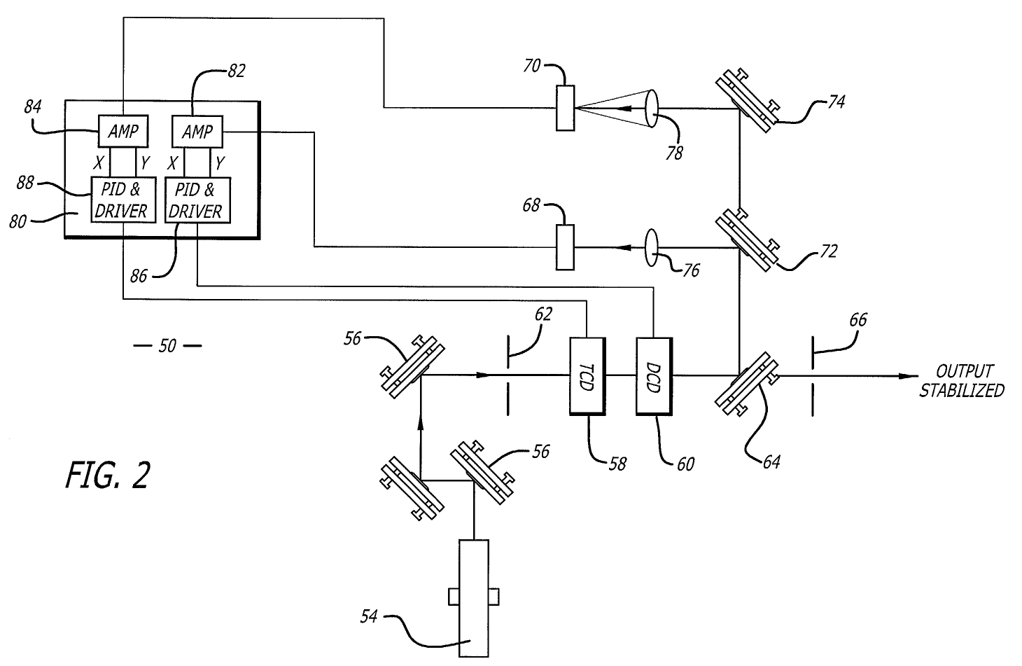

Referring to the drawings more particularly by reference numbers, FIG. 2 shows a stabilization module 50. The module 50 can stabilize and maintain a light beam 52 that is emitted from a light source 54. The beam 52 travels along an optical path. The light source 54 may be a laser that emits a laser beam. The beam 52 can be reflected by bending mirrors 56. The module 50 may be a separate assembly that is attached to the light source 54 and mirrors 56. For example, the module 50 may be attached to a laser machine or a fiber Bragg forming apparatus. The module stabilizes the laser beam of the equipment.

The module 50 includes a tilt compensation device 58 and a displacement compensation device 60. The tilt compensation device 58 can vary the tilt angle of the beam 52. The displacement compensation device 60 can laterally displace the beam 52. The beam 52 may enter the module 50 through an input aperture 62. The beam 52 may exit the module 50 through a semi-reflective mirror 64 and exit aperture 66.

A portion of the light beam 52 may be directed onto photodetectors 68 and 70 by semi-reflective mirror 64 and bending mirrors 72 and 74. An imaging lens 76 images the surface of the mirror 64 onto photodetector 68. A focusing lens 78 focuses the beam onto photodetector 70. The photodetectors 68 and 70 may be quadrature devices that can provide output signals that are processed to determine beam movement.

Photodetector 68 is used to determine lateral displacement of the beam 52. Photodetector 70 is used to determine an undesirable tilt of the beam 52. Photodetector 70 is preferably located at the focal point of lens 78 so that the detector 70 only detects a change in the beam tilt independent of any lateral displacement of the beam 52.

The photodetectors 68 and 70 are connected to a controller 80. The controller 80 includes amplifiers 82 and 84 to amplify the output signals of the detectors 68 and 70. The controller 80 also contains error control and driver circuits 86 and 88 that provide output signals to the compensation devices 60 and 58, respectively. The error control circuits 86 and 88 may include proportional-integral-derivative (PID) feedback control for eliminating tilt and displacement errors detected by photodetectors 68 and 70, respectively.

In operation, the light beam 52 is directed through the module 10. A deviation in the tilt angle of the beam 52 will be detected by photodetector 70, processed by control circuit 88 and corrected by actuating the tilt compensation device 58. Likewise, a lateral deviation of the beam 52 will be detected by photodetector 68, processed by control circuit 86 and corrected by actuating the displacement compensation device 60. Providing separate tilt and displacement compensation and detection systems de-couples the tilt error from the displacement error. For example, if the systems were not de-coupled, the tilt compensation device would interpret pure lateral displacement as a tilt error and actually increase the error. With the arrangement shown in FIG. 2, the tilt compensation device 58 corrects the tilt so that the beam is travelling parallel to the desired optical path. The displacement device 60 can then move the beam over to the desired position.

It is preferable to place the displacement compensation device 60 after the tilt compensation device 58 on the optical path of the beam 52. Placing the displacement device 60 before the tilt device 58 would increase the amount of displacement that the device 60 would have to compensate for by the tangent of the tilt error multiplied by the propagation between devices 58 and 60. This would reduce the dynamic range of the module 50.

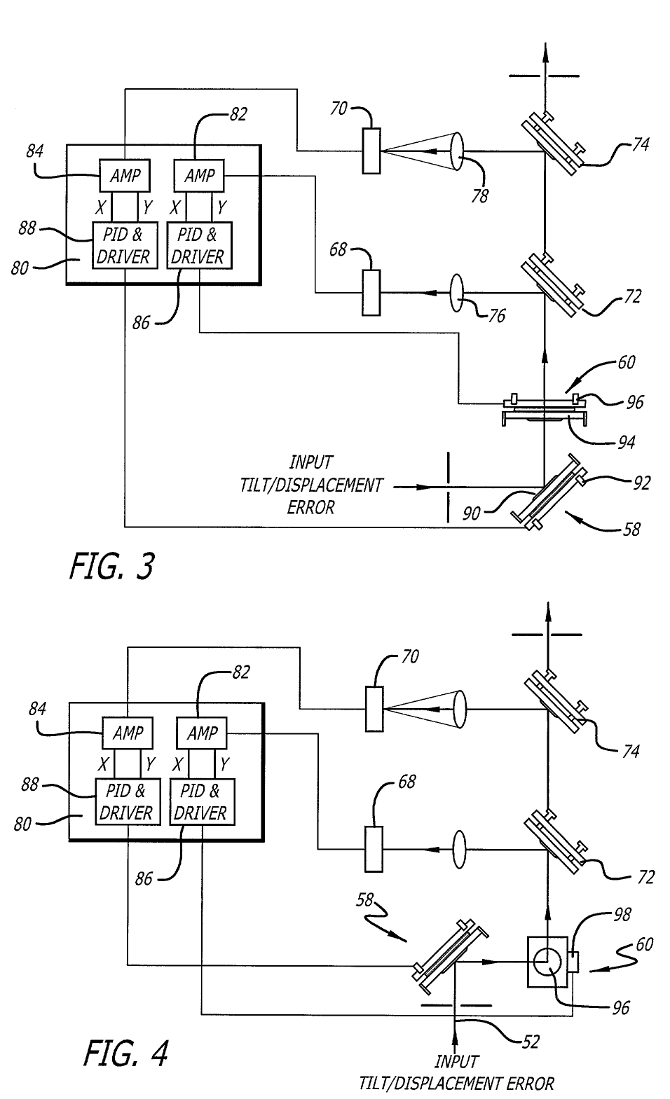

FIG. 3 shows an embodiment of the module 50 wherein the tilt compensation device 58 is a fast steering mirror (FSM) and the displacement compensation device 60 is a fast steering plate (FSP). The FSM includes a mirror 90 that can be pivoted by a plurality of actuators 92 driven by control circuit 88. The FSP includes a transmissive plate 94 that is pivoted by actuators 96 driven by control circuit 86. The plate 94 uses refraction and varying impingement angles to vary the lateral position of the beam. This embodiment is preferable for monochromatic light beams. A light beam with multiple wavelengths may produce chromatic feedback errors.

FIG. 4 shows another embodiment wherein the displacement compensation device 60 has a pair of reflective mirrors 96 that are each moved by a linear translator 98 (only one mirror is shown). One mirror 96 may move the beam 52 along an x axis, the other mirror 96 may move the beam 52 along an orthogonal y axis. Each mirror 96 may reflect the beam 52 in an orthogonal direction resulting in 90 degree turn from the input beam 52. The translators 98 may include voice coil motors.

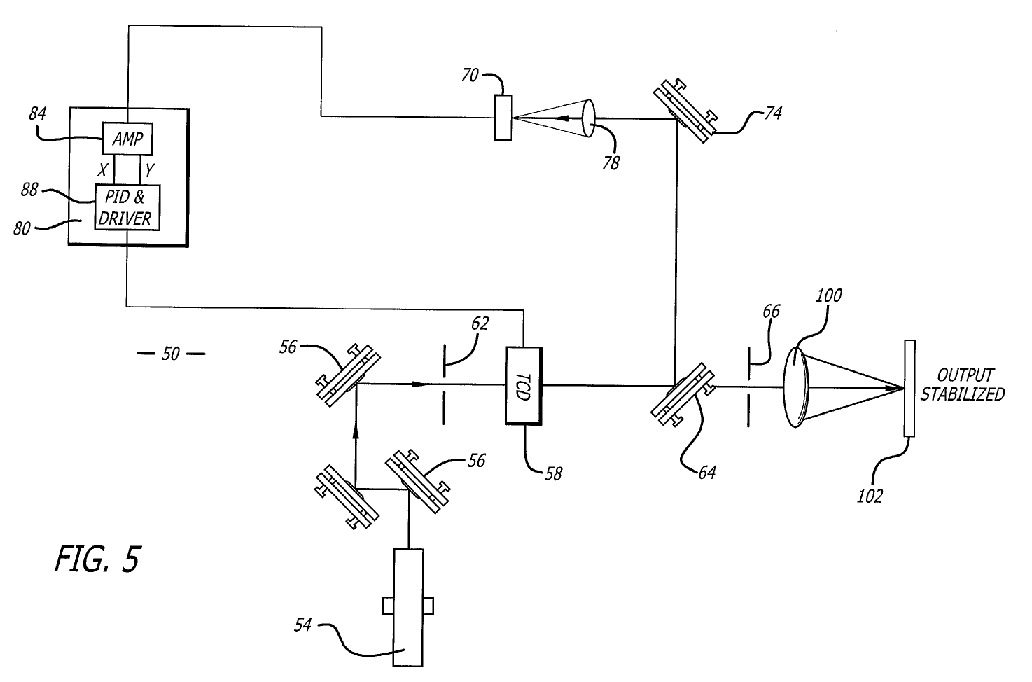

FIG. 5 shows another embodiment that has a scan lens 100 which focuses the light beam to a point on a work piece 102. Focusing the beam to a point eliminates the need for the displacement compensation device and accompanying feedback system.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

For example, the tilt compensation device 58 and displacement compensation device 60 may be mounted to the same mechanical platform, or mounted to different mechanical platforms.

What is claimed is:

1. A stabilization module that can stabilize a light beam that travels along an optical path, comprising:
a tilt compensation device located in the optical path;
a tilt feedback assembly coupled to said tilt compensation device;
a displacement compensation device located in the optical path; and,
a displacement feedback assembly coupled to said displacement compensation device.

2. The module of claim 1, wherein said displacement compensation device includes a pivoting transmissive plate.

3. The module of claim 1, wherein said displacement compensation device includes a mirror coupled to a translating actuator.

4. The module of claim 1, wherein said tilt compensation device includes a pivoting mirror.

5. The module of claim 1, wherein said displacement compensation device is located between said tilt compensation device and said displacement feedback assembly.

6. The module of claim 1, wherein said tilt feedback assembly includes a tilt detection mirror, a photodetector and a lens that focuses a portion of the light beam onto said photodetector.

7. The module of claim 1, wherein displacement detection assembly includes a displacement feedback mirror, a photodetector and a lens.

8. The module of claim 1, further comprising an input aperture and an output aperture in the optical path.

9. A stabilization module that can stabilize a light beam that travels along an optical path, comprising:
tilt detection means for detecting a tilt error of the light beam;
tilt means for varying an angle of the light beam in accordance with the tile error;
displacement detection means for detecting a displacement error of the light beam; and,
displacement means for varying a displacement of the light beam in accordance with the displacement error.

10. The module of claim 9, wherein said displacement means includes a pivoting transmissive plate.

11. The module of claim 9, wherein said displacement means includes a mirror coupled to a translating actuator.

12. The module of claim 9, wherein said tilt means includes a pivoting mirror.

13. The module of claim 9, wherein said displacement means is located between said tilt means and said displacement detection means.

14. The module of claim 9, wherein said tilt detection means includes a tilt detection mirror, a photodetector and a lens that focuses a portion of the light beam onto said photodetector.

15. The module of claim 9, wherein said displacement detection means includes a displacement detection mirror, a photodetector and a lens.

16. The module of claim 9, further comprising an input aperture and an output aperture in the optical path.

17. A method for stabilizing a light beam that travels along an optical path, comprising:
determining a tilt error in the light beam;
varying an angle of the light beam in response to the tilt error with a tilt compensation device;
determining a displacement error in the light beam; and,
varying a displacement of the light beam in response to the displacement error with a displacement compensation device.

18. The method of claim 17, wherein the displacement error is detected with a photodetector located at a focal point of a lens.

19. The method of claim 17, wherein the displacement of the light beam is varied by tilting a transmissive plate.

20. The method of claim 17, wherein the displacement of the light beam is varied by translating a mirror.

21. The method of claim 17, wherein the angle of the light beam is varied by pivoting a mirror.

22. A stabilization module that can stabilize a light beam that travels along an optical path to a workpiece, comprising:
a tilt compensation device located in the optical path;
a tilt feedback assembly coupled to said tilt compensation device; and,
a lens that focuses the light beam onto a point of the workpiece.

23. The module of claim 22, wherein said tilt compensation device includes a pivoting mirror.

24. The module of claim 22, wherein said tilt feedback assembly includes a tilt detection mirror, a photodetector and a lens that focuses a portion of the light beam onto said photodetector.

25. A stabilization module that can stabilize a light beam that travels along an optical path onto a workpiece, comprising:
tilt detection means for detecting a tilt error of the light beam;
tilt means for varying an angle of the light beam in accordance with the tilt error; and,
lens means for focusing the light beam onto a point of the workpiece.

26. The module of claim 25, wherein said tilt means includes a pivoting mirror.

27. The module of claim 25, wherein said tilt detection means includes a tilt detection mirror, a photodetector and a lens that focuses a portion of the light beam onto said photodetector.

28. A method for stabilizing a light beam that travels along an optical path onto a workpiece, comprising:
focusing the light beam onto a point of the workpiece;
determining a tilt error in the light beam; and,
varying an angle of the light beam in response to the tilt error with a tilt compensation device.

29. The method of claim 28, wherein the angle of the light beam is varied by pivoting a mirror.
